(19) United States
(12) Patent Application Publication
(10) Pub. No.: US 2026/0346823 A1
(43) Pub. Date: Nov. 5, 2026

(54) ACTUATION DEVICE FOR A MASTER CYLINDER, ASSEMBLY FOR A HYDRAULIC BRAKE SYSTEM

(71) Applicant: Robert Bosch GmbH, Stuttgart (DE)

(72) Inventors: Willi Nagel, Remseck/Hochdorf (DE); Bernd Haeusser, Neckarwestheim (DE); Christian Jammes, Ludwigsburg (DE)

(21) Appl. No.: 19/115,464

(22) PCT Filed: Feb. 16, 2024
(86) PCT No.: PCT/EP2024/053986

§ 371 Date: Mar. 26, 2025

(30) Foreign Application Priority Data
Feb. 17, 2023 (DE) 10 2023 201 379.7

(51) Int. Cl. B60T 13/16; B60T 13/74

(52) U.S. Cl. CPC B60T 13/162; B60T 13/745

(57) ABSTRACT

An actuation device for a master cylinder. The actuation device has a gearing device and an electric motor for driving the gearing device. The gearing device has a spindle gear unit with a threaded spindle and a spindle nut. The threaded spindle or the spindle nut can be moved by the electric motor to actuate the master cylinder. The threaded spindle which can be moved by the electric motor or the spindle nut which can be moved by the electric motor is paired with a spring element which applies a restoring force to the threaded spindle or the spindle nut. The restoring force is oriented opposite the actuation of the master cylinder. The spring element is kept biased between the threaded spindle and the spindle nut. The threaded spindle and/or the spindle nut can be rotated relative to the spring element.

### FIELD

The present invention relates to an actuation device for a master cylinder, wherein the actuation device has a gearing device and an electric motor for driving the gearing device, wherein the gearing device has a spindle gear unit with a threaded spindle and a spindle nut, wherein the threaded spindle or the spindle nut can be moved by the electric motor in order to actuate the master cylinder, and wherein the threaded spindle which can be moved by the electric motor or the spindle nut which can be moved by the electric motor is paired with a spring element which applies a restoring force to the threaded spindle or the spindle nut, said restoring force being oriented opposite the actuation of the master cylinder.

Furthermore, the present invention relates to an assembly for a hydraulic brake system, including an actuatable master cylinder, and including an actuation device for actuating the master cylinder.

### BACKGROUND INFORMATION

A hydraulic brake system of a motor vehicle typically has a plurality of friction brake devices, which are hydraulically connected to a master cylinder of the brake system. If the master cylinder is actuated, hydraulic fluid is moved out of the master cylinder into slave cylinders of the friction brake devices, so that the friction brake devices then generate a friction braking torque. For actuating the master cylinder, an actuation device is typically present. With the increasing electrification of motor vehicles, actuation devices of brake systems are also becoming increasingly electrified. For this purpose, the actuation devices have a gearing device and an electric motor for driving the gearing device. The gearing device often has a spindle gear unit having a threaded spindle and a spindle nut. The threaded spindle or the spindle nut can be moved by the electric motor in order to actuate the master cylinder.

In a patent application by the applicant which has not yet been published, an actuation device is described with which the threaded spindle can be moved by the electric motor. In order to ensure that the moved threaded spindle is reset even upon a failure of the electric motor, a spring element is paired with the threaded spindle, which spring element applies a restoring force to the threaded spindle, said restoring force being oriented opposite the actuation of the master cylinder. The restoring force pushes the threaded spindle away from the master cylinder. The spring element is kept biased between the threaded spindle and a bearing plate fixed to the housing. In order to bridge a radial offset between the threaded spindle and the bearing plate, the spring element is designed to taper conically.

### SUMMARY

An actuation device according to the present invention may have the advantage that the load on the electric motor and the gearing device can be reduced compared to conventional actuation devices. According to an example embodiment of the present invention, the spring element is kept biased between the threaded spindle and the spindle nut, and the threaded spindle and/or the spindle nut can be rotated relative to the spring element. For conically tapered spring elements, the spring characteristic curve is typically nonlinear. Instead, the restoring force provided increases disproportionately with a compression of the spring element. The use of a conically tapered spring element in an actuation device for a master cylinder therefore leads to an increased load on the electric motor and the gearing device. Since the spring element is kept biased between the threaded spindle and the spindle nut according to the present invention, the use of a conically tapered spring element is not necessary. At most, a smaller radial offset between the threaded spindle and the spindle nut needs to be bridged. With a spindle gear unit, the threaded spindle and the spindle nut can be rotated relative to one another. When the terms “axial” and “radial” are used in the disclosure, the terms refer to the axis of rotation of the rotatably mounted gearing element of the spindle gear unit, unless a different reference is expressly disclosed. In order to prevent the spring element from being applied with a torque by a rotation of the rotatably mounted gearing element of the spindle gear unit, i.e., the spindle nut or the threaded spindle, the threaded spindle and/or the spindle nut can be rotated relative to the spring element. In particular, only the threaded spindle can be rotated relative to the spring element. A first end of the spring element paired with the threaded spindle is thus rotatably mounted onto the threaded spindle. A second end of the spring element paired with the spindle nut is connected to the spindle nut in a rotationally fixed manner. Alternatively, only the spindle nut can be rotated relative to the spring element. The second end of the spring element is then rotatably mounted on the spindle nut. The first end of the spring element is connected to the threaded spindle in a rotationally fixed manner. Alternatively, both the spindle nut and the threaded spindle can be rotated relative to the spring element. As above-mentioned, both the threaded spindle and the spindle nut can be moved by the electric motor. Preferably, the threaded spindle can be moved by the electric motor. The spring element is then arranged in such a way that it applies a restoring force to the threaded spindle, said restoring force being oriented opposite the actuation of the master cylinder. The restoring force thus pushes the threaded spindle away from the master cylinder. Since the spring element is kept biased between the threaded spindle and the spindle nut according to the present invention, the spring element then applies a force to the spindle nut which is oriented opposite the restoring force. Alternatively, the spindle nut can preferably be moved by the electric motor. The spring element is then arranged in such a way that it applies the restoring force to the spindle nut, said restoring force being oriented opposite the actuation of the master cylinder. Since the spring element is kept biased between the threaded spindle and the spindle nut according to the present invention, the spring element then applies a force to the threaded spindle which is oriented opposite the restoring force.

According to a preferred embodiment of the present invention, the spring element is designed to be cylindrical. With a cylindrical spring element, a linear spring characteristic curve is typically obtained, which is associated with a low load on the electric motor and the gearing device. According to an alternative exemplary embodiment, the spring element is designed to taper conically, wherein an opening angle of the conically tapered spring element is then preferably smaller than 10°.

Preferably, according to an example embodiment of the present invention, the spring element is a coil spring. Such spring elements can be obtained cost-effectively. Particularly preferably, the threaded spindle and the spring element are arranged concentrically to one another.

According to a preferred embodiment of the present invention, the threaded spindle has a first end facing away from the master cylinder, and the spring element applies the restoring force to the first end of the threaded spindle. In this embodiment, the threaded spindle can be moved by the electric motor. The first end of the threaded spindle is easily accessible for the arrangement of the spring element, and therefore this embodiment of the actuation device is structurally simple to implement.

According to a preferred embodiment of the present invention, a sleeve is arranged at the first end of the threaded spindle, which sleeve protrudes axially beyond the first end of the threaded spindle and the first end of the spring element paired with the threaded spindle is arranged on an axial stop of the sleeve. The first end of the spring element is thus not arranged directly on the threaded spindle, but on the sleeve. The sleeve can provide a structure which is particularly suitable for the arrangement of the first end of the spring element. Preferably, the sleeve has a radial projection protruding radially outward, which forms the axial stop for the first end of the spring element. Due to the radial projection, any radial offset that may exist between the threaded spindle and the spindle nut can be bridged. According to an alternative embodiment of the present invention, preferably, the first end of the spring element is arranged directly on the threaded spindle.

Preferably, according to an example embodiment of the present invention, the sleeve is rotatably mounted onto the threaded spindle. At least the threaded spindle can be rotated relative to the spring element. Since the first end of the threaded spindle is easily accessible as mentioned above, the rotatable mounting of the sleeve on the threaded spindle can be implemented in a structurally simple manner. Based on the small radial extension of the threaded spindle, the bearing of the sleeve on the threaded spindle can also be implemented cost-effectively. Preferably, the sleeve is rotatably mounted onto the threaded spindle by a rotary bearing having a plurality of rolling elements. However, the sleeve can also be rotatably mounted onto the threaded spindle by means of a plain bearing.

According to a preferred example embodiment of the present invention, the sleeve is axially secured on the threaded spindle by means of a clip ring mounted onto the threaded spindle. Preferably, the clip ring engages radially in a radially outwardly open circumferential groove of the threaded spindle in order to secure the sleeve. Preferably, the clip ring interacts with the above-mentioned rolling elements of the pivot bearing in order to secure the sleeve. Alternatively, the clip ring interacts directly with the sleeve in order to secure the sleeve.

According to a preferred example embodiment of the present invention, the second end of the spring element paired with the spindle nut is arranged on an axial stop of the spindle nut which is axially opposite the axial stop of the sleeve. Since the two axial stops are axially opposite one another, a cylindrical spring element, in particular a cylindrical coil spring, can be used. The second end of the spring element abuts directly against the spindle nut, specifically on the axial stop. According to an alternative embodiment, the second end abuts only indirectly against the spindle nut, for example on an element rotatably mounted on the spindle nut.

According to a preferred example embodiment of the present invention, the spindle nut has a first axial portion facing the master cylinder and a second axial portion facing away from the master cylinder, wherein the first axial portion has an internal toothing paired with the threaded spindle, and wherein the second axial portion radially encloses the spring element at least in sections. Since the second axial portion radially encloses the spring element, the second axial portion prevents the spring element from bending during operation. Preferably, a circumferential stop step is formed at the transition from the first axial portion to the second axial portion, wherein the stop step forms the axial stop on which the second end of the spring element is arranged.

Preferably, according to an example embodiment of the present invention, the actuation device has a pressure piston which can be movably mounted in an axial opening of the threaded spindle and can be moved by an input rod, wherein the master cylinder can be actuated by a movement of the pressure piston. The pressure piston can thus be moved by the input rod. The input rod is coupled or can be coupled to a brake pedal, so that the pressure piston can ultimately be moved by actuating the brake pedal. Since the master cylinder can be actuated by moving the pressure piston, the user can still actuate the master cylinder even upon a failure of the electric motor.

Preferably, the actuation device has a further spring element, which applies a restoring force to the threaded spindle and the pressure piston, said restoring force being oriented opposite the actuation of the master cylinder. In this embodiment, the threaded spindle is the gearing element of the spindle gear unit which can be moved by the electric motor. In addition to the spring element, there is therefore a further spring element. Due to the further spring element, both the threaded spindle and the pressure piston can be reset. The provision of the spring element and the further spring element instead of a single spring element, which applies the restoring force to both the gearing element and the pressure piston, has the advantage that different restoring forces can be implemented for the gearing element and the pressure piston. Purely for the sake of example, the restoring force acting on the pressure piston should not exceed 200 N. However, such a restoring force may not be sufficiently high in order to reset the threaded spindle upon a failure of the electric motor. The spring element, which is kept biased between the threaded spindle and the spindle nut, can increase the restoring force acting on the threaded spindle, without necessarily increasing the restoring force acting on the pressure piston.

According to a preferred example embodiment of the present invention, the threaded spindle and the spindle nut are mechanically coupled to the pressure piston in such a way that the threaded spindle and the spindle nut can be moved together by a movement of the pressure piston, at least upon a failure of the electric motor. For example, the pressure piston is designed to transmit a force acting in the direction of the master cylinder to the threaded spindle according to its movement. An external toothing of the threaded spindle also meshes with an internal toothing of the spindle nut in such a way that the force is also transmitted by means of the threaded spindle to the spindle nut. Since the threaded spindle and the spindle nut can be moved together or are moved upon a failure of the electric motor, the spring element kept biased between the threaded spindle and the spindle nut is not compressed. Accordingly, the restoring force provided by the spring element does not have to be overcome by a user of the brake pedal upon a failure of the electric motor.

According to a preferred example embodiment of the present invention, the gearing device has a worm wheel which radially encloses the spindle nut, wherein a multi-tooth profile of the worm wheel, which profile is directed radially inward, meshes with a multi-tooth profile of the spindle nut, which profile is directed radially outward. During fault-free operation of the electric motor, a reaction force acting between the multi-tooth profiles prevents the spindle nut from being axially moved. Upon a failure of the electric motor, this reaction force is eliminated, so that the spindle nut and the threaded spindle can then be moved together.

Preferably, the multi-tooth profile of the spindle nut is formed at least in sections on the second axial portion of the spindle nut. This has the advantage that the two multi-tooth profiles remain in engagement with one another even upon a movement of the spindle nut in the axial direction. Preferably, the multi-tooth profile of the spindle nut extends to an end of the second axial portion facing away from the master cylinder.

An assembly according to an example embodiment of the present invention, includes the design of the actuation device according to the present invention. This also results in the advantages already mentioned. Further preferred features and combinations of features result from what was described above and from the rest of the disclosure herein.

The present invention is explained in more detail below with reference to the figures.

### BRIEF DESCRIPTION OF THE DRAWINGS

FIG. 1 shows an assembly for a hydraulic brake system, according to an example embodiment of the present invention.

FIG. 2 is a sectional view of the assembly according to an example embodiment of the present invention.

FIG. 3 is a further sectional view of the assembly, according to an example embodiment of the present invention.

### DETAILED DESCRIPTION OF EXAMPLE EMBODIMENTS

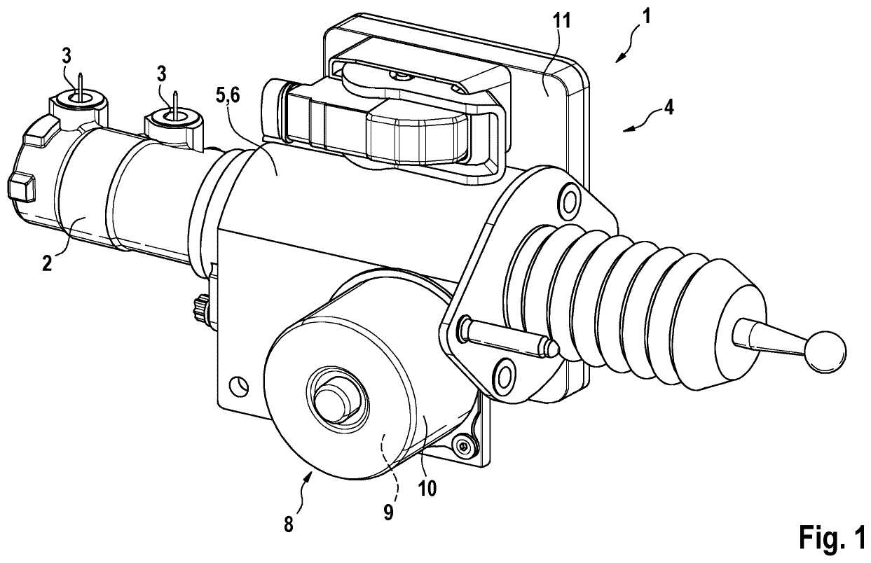

FIG. 1 is a perspective view of an assembly 1 for a hydraulic brake system (not shown in more detail) of a motor vehicle. The assembly 1 has an actuatable master cylinder 2 with a plurality of hydraulic connections 3. Two hydraulic pistons 13, not visible in FIG. 1, are movably mounted in the master cylinder 2. If the assembly 1 is installed in a brake system as intended, the hydraulic connections 3 are fluidically connected to slave cylinders of friction brake devices of the brake system, so that the friction brake devices can be actuated by actuating the master cylinder 2.

The assembly 1 also has an actuation device 4 for actuating the master cylinder 2. The actuation device 4 has a housing 5. The master cylinder 2 is arranged on a first end face 12 of the housing 5. In the present case, the housing 5 is designed to be tubular and thus has a circumferential casing wall 6, which encloses a housing interior 7 of the housing 5. The actuation device 4 also has a drive assembly 8, which is arranged on the housing 5. The drive assembly 8 has an electric motor 9, which is arranged in a motor housing 10 and is therefore not visible in FIG. 1. The actuation device 4 also has a control unit 11. The control unit 11 is arranged on the housing 5 on a side of the housing 5 facing away from the drive assembly 8. The control unit 11 is designed to control the electric motor 9.

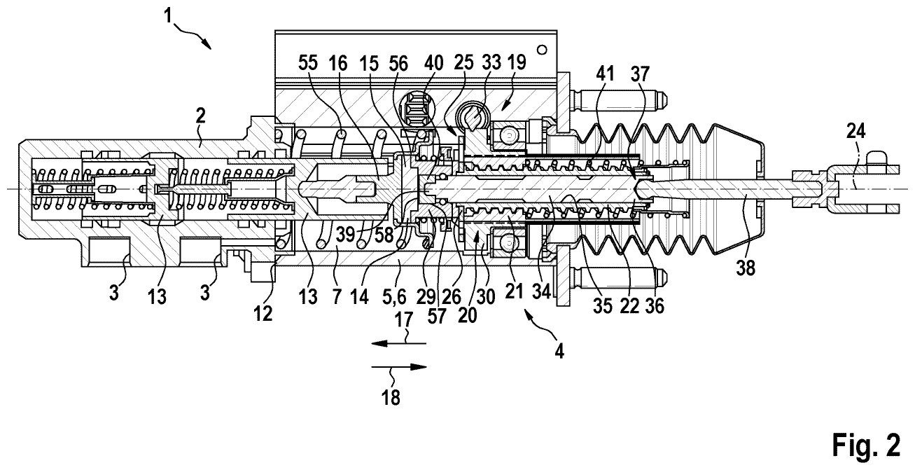

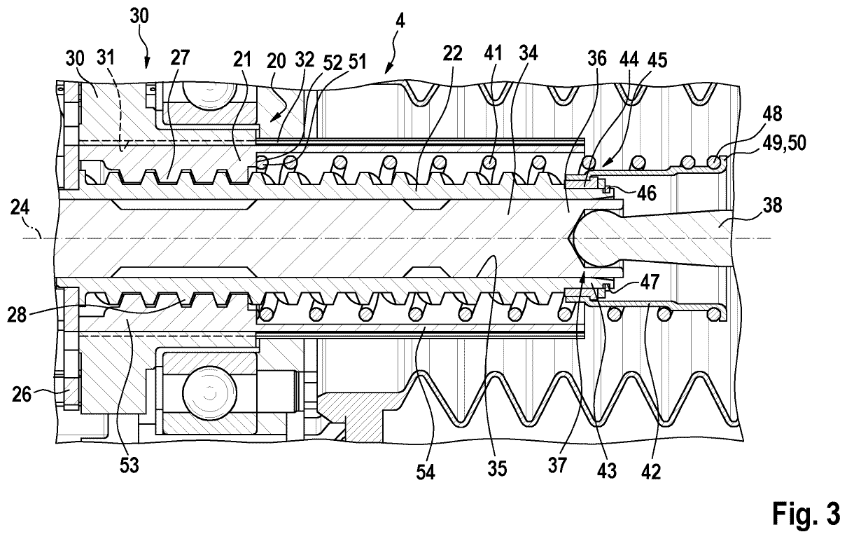

The design of the actuation device 4 is explained in more detail below, with additional reference to FIGS. 2 and 3. For this purpose, FIG. 2 is a sectional view of the assembly 1. FIG. 3 is a sectional view of a section of the actuation device 4. The actuation device 4 has a movable coupling element 14. In the present case, the coupling element 14 has an elastically deformable coupling disk 15 and a rigid coupling rod 16. The coupling element 14 can be moved in a first direction 17 and in a second direction 18 opposite the first direction 17. The coupling element 14 is operatively connectable or operatively connected to the master cylinder 2 in such a way that the master cylinder 2 can be actuated by a movement of the coupling element 14 in the first direction 17. Actuation of the master brake cylinder 2 is understood to mean that the hydraulic pistons 13 are moved in the first direction 17. If the assembly 1 is installed in a brake system as intended, hydraulic fluid is moved from the master cylinder 2 into the slave cylinders of the wheel brake devices.

The actuation device 4 also has a gearing device 19. The gearing device 19 is operatively connected to the electric motor 9 in such a way that the gearing device 19 can be driven by the electric motor 9. The gearing device 19 has a spindle gear unit 20. The spindle gear unit 20 has a spindle nut 21 and a threaded spindle 22. In the present case, the spindle nut 21 is rotatably mounted. An axis of rotation 24 of the spindle nut 21 is aligned parallel to the directions 17 and 18. The threaded spindle 22 is paired with an anti-rotation device 25, which acts between the threaded spindle 22 and the housing 5. For this purpose, a rotation-locking element 26 is provided, which is fastened to the threaded spindle 22, in the present case to an end of the threaded spindle 22 facing the coupling element 14 or the master cylinder 2. The rotation-locking element 26 interacts with the housing 5 to form the anti-rotation device 25. An internal toothing 27 of the spindle nut 21 meshes with an external toothing 28 of the threaded spindle 22 in such a way that the threaded spindle 22 can be moved by rotating the spindle nut 21, specifically optionally in the first direction 17 or in the second direction 18. The threaded spindle 22 is operatively connected to the coupling element 14 in such a way that the coupling element 14 can be moved in the first direction 17 by moving the threaded spindle 22. In the present case, a push body 29 is fastened to the rotation-locking element 26. The push body 29 protrudes from the rotation-locking element 26 in the direction of the coupling element 14 in such a way that the push body 29 axially abuts against the coupling element 14 in relation to the axis of rotation 24 of the spindle nut 21.

The spindle nut 21 can be rotated by the electric motor 9. Accordingly, the threaded spindle 22 can be moved by the electric motor 9. For this purpose, the gearing device 19 in the present case has a worm wheel 30, which radially encloses the spindle nut 21. A multi-tooth profile 31 of the worm wheel 30, which profile is directed radially inward, meshes with a multi-tooth profile 32 of the spindle nut 21, which profile is directed radially outward. The gearing device 19 also has a worm shaft 33 that can be rotated by the electric motor 9. An output toothing of the worm shaft 33 meshes with a drive toothing of the worm wheel 30 in such a way that the worm wheel 30 and thus the spindle nut 21 can be rotated by rotating the worm shaft 33.

The actuation device 4 also has a pressure piston 34 which is movably mounted relative to the threaded spindle 22. The pressure piston 34 is movably mounted in an axial opening 35 of the threaded spindle 22. A first end 36 of the pressure piston 34 facing away from the master cylinder 2 or the coupling element 14 is operatively connected to an input rod 38 by a ball joint 37 in such a way that the pressure piston 34 can be moved by the input rod 38. The input rod 38 is in turn coupled or can be coupled to a brake pedal of the brake system. If the input rod 38 is coupled to the brake pedal, the pressure piston 34 can be moved by means of the brake pedal. A pressure cap 40 is fastened to a second end 39 of the pressure piston 34 facing the coupling element 14. The pressure cap 40 protrudes into an axial opening 57 of the push body 29, so that an end face 58 of the pressure cap 40 can be brought into contact with the coupling element 14. The coupling element 14 can thus also be moved by a movement of the pressure piston 34, so that the master cylinder 2 can be actuated by a movement of the pressure piston 34. In the initial position of the actuation device 4 shown in FIG. 2, the pressure cap 40 is axially spaced from the coupling element 14.

The coupling element 14 can thus be moved both by the electric motor 9 and by the brake pedal. If the coupling element 14 is moved by the electric motor 9, the electric motor 9 acts on the coupling element 14 by means of the gearing device 19, the rotation-locking element 26 and the push body 29. If the coupling element 14 is moved by the brake pedal, the brake pedal acts on the coupling element 14 by means of the input rod 38, the pressure piston 34 and the pressure cap 40.

The actuation device 4 also has a spring element 41. The spring element 41 is designed to apply a restoring force to the threaded spindle 22 which can be moved by the electric motor 9, said restoring force being oriented opposite the actuation of the master cylinder 2. The restoring force thus acts in the second direction 18 on the threaded spindle 22 and pushes the threaded spindle 22 away from the master cylinder. Due to the spring element 41, the threaded spindle 22 following actuation of the master cylinder 2 is reset. The spring element 41 is kept biased between the threaded spindle 22 and the spindle nut 21. Accordingly, the spring element 41 applies a force to the spindle nut 21 in the direction of the master cylinder 2, i.e., in the first direction 17.

The actuation device 4 has a sleeve 42 which is arranged on a first end 43 of the threaded spindle 22 facing away from the master cylinder 2. The sleeve 42 is pushed onto the threaded spindle 22 and is rotatably mounted onto the threaded spindle 22. For this purpose, a rotary bearing 45 having a plurality of rolling elements 44 is provided, which rotary bearing acts between the sleeve 42 and the threaded spindle 22. The sleeve 42 is axially secured on the threaded spindle 22 by means of a clip ring 46. The clip ring 46 is mounted onto the threaded spindle 22 and engages radially in a radially outwardly open circumferential groove 47 of the threaded spindle 22. A first end 48 of the spring element 41 paired with the threaded spindle 22 is arranged on an axial stop 49 of the sleeve 42. The axial stop 49 is formed by a radial projection 50 of the sleeve 42 protruding radially outward. The spring element 41 applies the restoring force to the threaded spindle 22 or the first end 43 of the threaded spindle 22 by means of the sleeve 42. Since the spring element 41 is not arranged directly on the threaded spindle 22, but on the sleeve 42, the threaded spindle 22 and the spring element 41 can be rotated relative to one another. In this respect, a rotation of the spindle nut 21 relative to the threaded spindle 22 is not or at most only slightly hindered by the spring element 41.

A second end 51 of the spring element 41 paired with the spindle nut 21 is arranged on an axial stop 52 of the spindle nut 21 which is axially opposite the axial stop 49 of the sleeve 42. Since the axial stops 49 and 52 are axially opposite one another, a cylindrically designed spring element 41 can be used as the spring element 41. A cylindrically designed spring element 41 is therefore particularly advantageous, because it has a linear spring characteristic curve. In the present case, the spring element 41 is designed as a coil spring 41.

The spindle nut 21 has a first axial portion 53 facing the master cylinder 2 and a second axial portion 54 facing away from the master cylinder 2. The first axial portion 53 has the internal toothing 27. The second axial portion 54 is free of the internal toothing 27. The second axial portion 54 encloses the spring element 41 at least in sections. The above-mentioned multi-tooth profile 32 directed radially outward is formed on both the first axial portion 53 and the second axial portion 54. In the present case, the multi-tooth profile 32 extends from an end of the spindle nut 21 facing the master cylinder 2 to an end of the spindle nut 21 facing away from the master cylinder 2.

The actuation device 4 also has a further spring element 55. The further spring element 55 is kept biased between a return body 56 fastened to the coupling element 14 and the master cylinder 2. Accordingly, the further spring element 55 applies a restoring force, acting in the second direction 18, to the coupling element 14, and thus to both the threaded spindle 22 and the pressure rod 34.

The following is a more detailed explanation of how the actuation device 4 works. During fault-free operation of the electric motor 9, the electric motor 9 is controlled according to a detected sliding position of the pressure piston 34. If the pressure piston 34 is moved in the first direction 17, the electric motor 9 is controlled in such a way that the threaded spindle 22 is moved in the first direction 17 in order to actuate the master cylinder 2. The threaded spindle 22 is moved in the first direction 17 against the restoring forces provided by the spring element 41 and the further spring element 55. Following the actuation of the master cylinder 2, the threaded spindle 22 is reset by the restoring forces provided by means of the spring elements 41 and 55. The pressure piston 34 is only reset by the restoring force provided by means of the further spring element 55. However, the restoring force provided by the spring element 41 does not act on the pressure piston 34. Upon a failure of the electric motor 9, a movement of the threaded spindle 22 in the first direction 17 by means of the electric motor 9 is not possible. However, the master cylinder 2 can be actuated by moving the pressure piston 34. For this purpose, a user only has to overcome the restoring force provided by the further spring element 55. If the coupling element 14 is moved in the first direction by the pressure rod 34, a force acting in the first direction 17 also acts on the threaded spindle 22 based on the mechanical operative connection between the coupling element 14 and the threaded spindle 22. This force causes the threaded spindle 22 and the spindle nut 21 to be moved together with the pressure piston 34. A compression of the spring element 41 does not take place. Based on the dimensioning of the multi-tooth profile 32 of the spindle nut 21 directed radially outward, the multi-tooth profiles 31 and 32 are prevented from becoming disengaged upon a movement of the spindle nut 21. During fault-free operation of the electric motor 9, a movement of the spindle nut 21 is prevented by a reaction force acting between the multi-tooth profile 31 and the multi-tooth profile 32.

According to a further exemplary embodiment, the spindle nut 21 can be moved by the electric motor 9 instead of the threaded spindle 22. The spring element 41 then applies the restoring force acting in the second direction 18 to the spindle nut 21.

1-15. (canceled)

16. An actuation device for a master cylinder, comprising:
a gearing device; and
an electric motor configured to drive the gearing device;
wherein the gearing device has a spindle gear unit with a threaded spindle and a spindle nut, wherein the threaded spindle or the spindle nut can be moved by the electric motor to actuate the master cylinder, the threaded spindle which can be moved by the electric motor or the spindle nut which can be moved by the electric motor is paired with a spring element which applies a restoring force to the threaded spindle or the spindle nut, the restoring force being oriented opposite the actuation of the master cylinder; and
wherein the spring element is kept biased between the threaded spindle and the spindle nut, and the threaded spindle and/or the spindle nut can be rotated relative to the spring element.

17. The actuation device according to claim 16, wherein the spring element is cylindrical.

18. The actuation device according to claim 16, wherein the spring element is a coil spring.

19. The actuation device according to claim 16, wherein the threaded spindle has a first end facing away from the master cylinder, and the spring element applies the restoring force to the first end of the threaded spindle.

20. The actuation device according to claim 19, wherein a sleeve is arranged at the first end of the threaded spindle, which sleeve protrudes axially beyond the first end of the threaded spindle, and in that a first end of the spring element paired with the threaded spindle is arranged on an axial stop of the sleeve.

21. The actuation device according to claim 20, wherein the sleeve is rotatably mounted onto the threaded spindle.

22. The actuation device according to claim 21, wherein the sleeve is axially secured on the threaded spindle by a clip ring mounted onto the threaded spindle.

23. The actuation device according to claim 20, wherein a second end of the spring element paired with the spindle nut is arranged on an axial stop of the spindle nut which is axially opposite the axial stop of the sleeve.

24. The actuation device according to claim 16, wherein the spindle nut has a first axial portion facing the master cylinder and a second axial portion facing away from the master cylinder, wherein the first axial portion has an internal toothing paired with the threaded spindle, and wherein the second axial portion radially encloses the spring element at least in sections.

25. The actuation device according to claim 16, wherein the actuation device has a pressure piston which is movably mounted in an axial opening of the threaded spindle and can be moved by an input rod, wherein the master cylinder can be actuated by a movement of the pressure piston.

26. The actuation device according to claim 25, wherein a further spring element, which applies a restoring force to the threaded spindle and the pressure piston, the restoring force of the further spring element being oriented opposite the actuation of the master cylinder.

27. The actuation device according to claim 26, wherein the threaded spindle and the spindle nut are mechanically coupled to the pressure piston in such a way that the threaded spindle and the spindle nut can be moved together by a movement of the pressure piston, at least upon a failure of the electric motor.

28. The actuation device according to claim 16, wherein the gearing device has a worm wheel which radially encloses the spindle nut, wherein a multi-tooth profile of the worm wheel, which profile is directed radially inward, meshes with a multi-tooth profile of the spindle nut, which profile is directed radially outward.

29. The actuation device according to claim 28, wherein the multi-tooth profile of the spindle nut is formed at least in sections on the second axial portion of the spindle nut.

30. An assembly for a hydraulic brake system, comprising:
an actuatable master cylinder; and
an actuation device for actuating the master cylinder, the actuation device including:
a gearing device, and
an electric motor configured to drive the gearing device,
wherein the gearing device has a spindle gear unit with a threaded spindle and a spindle nut, wherein the threaded spindle or the spindle nut can be moved by the electric motor to actuate the master cylinder, the threaded spindle which can be moved by the electric motor or the spindle nut which can be moved by the electric motor is paired with a spring element which applies a restoring force to the threaded spindle or the spindle nut, the restoring force being oriented opposite the actuation of the master cylinder, and
wherein the spring element is kept biased between the threaded spindle and the spindle nut, and the threaded spindle and/or the spindle nut can be rotated relative to the spring element.
